(19) United States
(12) Patent Application Publication
(10) Pub. No.: US 2026/0346814 A1
(43) Pub. Date: Nov. 5, 2026

(54) PUMP SYSTEM ATTACHMENT FOR VEHICLES TO IMPROVE TRACTION

(71) Applicant: William L. Kruse, JR., Gurnee, IL (US)

(72) Inventor: William L. Kruse, JR., Gurnee, IL (US)

(21) Appl. No.: 19/667,992

(22) Filed: May 5, 2026

Related U.S. Application Data
(60) Provisional application No. 63/799,879, filed on May 5, 2025.

(51) Int. Cl. B60S 1/68; B60B 39/02

(52) U.S. Cl. CPC B60S 1/68; B60B 39/022

(57) ABSTRACT

A vehicle-mounted tire fluid delivery system including a reservoir, external pump, fluid conduit, and spray outlets positioned within a wheel housing to apply liquid to a tire surface for traction modification, cleaning and smoke generation.

### RELATED MATTERS

This application claims priority to U.S. Provisional Patent Application 63/799,879, filed May 5, 2025, entitled “Built In Bleach Box”. The entire contents of this application are hereby incorporated herein by reference.

### TECHNICAL FIELD

The various embodiments herein relate to systems and methods to apply fluids or gas to the surface of tires to alter the friction level between the tire and a surface, or to add visual effects near the wheels of a vehicle.

### BACKGROUND

A motorized vehicle can create enough torque to its tires that the force exceeds the friction between the tire and the surface upon which the tire sits, and the tires will spin rather than the vehicle moving along the surface. The friction can be reduced due to wet conditions such as snowfall or rainfall, or foreign substances on the road such as oil. Friction can also be reduced with low-tread tires.

In some instances, such as with car enthusiasts, it is desired to spin the tires or partially spin the tires while the vehicle drifts. Unfortunately, if the surface is too dry, the torque from the engine will need to be significant, and the tire tread will be worn down.

There is a need in the art for a device or methods to alter the friction levels to enhance traction, or alternatively, increase tire spinning under any conditions while avoiding tire tread wear or overheated car components.

### BRIEF SUMMARY

Discussed herein are various embodiments herein relate to systems and methods to apply fluids or gas to the surface of tires to alter the friction level between the tire and a surface, or to add visual effects near the wheels of a vehicle.

In Example 1, a fluid dispensing device for deposition of fluid on to one or more vehicle tires comprises a fluid reservoir, a pumping mechanism to draw fluid from the fluid reservoir, and at least one nozzle attached to the pumping mechanism.

Example 2 relates to the fluid dispensing device according to Example 1, wherein the fluid dispensing device additionally comprises a controlling mechanism wherein the controlling mechanism can control the deposition of the fluid onto the vehicle tires.

Example 3 relates to the fluid dispensing device according to Example 2, wherein the controlling mechanism is a button.

Example 4 relates to the fluid dispensing device according to Example 1, wherein the fluid dispensing device comprises 2-8 nozzles.

Example 5 relates to the fluid dispensing device according to Example 1, wherein the fluid is one or more of water, calcium chloride, antifreeze, washer fluid, cleaning fluid, beet juice, chlorine bleach or a dye.

Example 6 relates to the fluid dispensing device according to Example 1, wherein the fluid dispensing device has at least one nozzle directed to each vehicle tire that spins from rotational energy.

Example 7 relates to the fluid dispensing device according to Example 1, wherein the fluid dispensing device comprises a fluid volume sensor.

Example 8 relates to the fluid dispensing device according to Example 1, wherein the at least one nozzle is affixed to a wheel well of a vehicle.

Example 9 relates to the fluid dispensing device according to Example 1, wherein the at least one nozzle is affixed to a mud flap of a vehicle.

In Example 10, fluid dispensing device for deposition of fluid on to one or more vehicle tires to modify vehicle traction between the vehicle tires and a surface comprising a fluid reservoir containing a fluid capable of providing increased traction between the vehicle tires and the surface, a pumping mechanism to draw fluid from the fluid reservoir, and at least one nozzle attached to the pumping mechanism.

In Example 11 a vehicle-mounted fluid delivery system comprising a fluid source, delivery mechanism, and at least one outlet positioned within a wheel housing or along a mud flap support structure.

Example 12 relates to system of claim 11 wherein multiple outlets are positioned around a tire or across a vehicle width.

Example 13 relates to the system of claim 11 wherein the delivery mechanism includes an electric pump, pressure system, or gravity system.

Example 14 relates to the system of claim 11 including adjustable flow control.

Example 15 relates to the system of claim 11 wherein outlets are mounted in a wheel well.

Example 16 relates to the system of claim 11 wherein outlets are mounted to a mud flap bar.

Example 17 relates to the system of claim 11 configured for multi-axle vehicles.

While multiple embodiments are disclosed, still other embodiments will become apparent to those skilled in the art from the following detailed description, which shows and describes various illustrative implementations. As will be realized, the various embodiments herein are capable of modifications in various obvious aspects, all without departing from the spirit and scope thereof. Accordingly, the drawings and the detailed description are to be regarded as illustrative in nature and not restrictive.

### BRIEF DESCRIPTION OF THE DRAWINGS

FIG. 1 shows a fluid reservoir and the attachments, according to one embodiment.

FIG. 2 shows fluid lines, four spray nozzles, two Y-adapters, and a user button, according to one embodiment.

FIG. 3 shows a nozzle mounted to a wheel well.

FIG. 4 shows a nozzle dispensing fluid on a tire.

FIG. 5 shows the electrical component enabling user control mounted on the fluid reservoir.

FIG. 6A is a schematic diagram of the fluid reservoir (100), external fluid pump (110), flow regulation device (170), and the fluid distribution network (120).

FIG. 6B is a schematic diagram of the wheel well (150) containing a vehicle tire (160) wherein the front and rear spray outlets (130, 140) are dispensing fluid on the tire.

FIG. 6C is a side view schematic diagram of the wheel well that also includes the control interface (180).

FIG. 6D is a schematic diagram of the power source (200) providing power to the control interface (180) which then controls the flow regulation device (170).

FIG. 6E is a schematic diagram of the arrangement of the front spray outlet (130), a quick connect (220), a tee connector (210) and a fluid distribution network (120).

### DETAILED DESCRIPTION

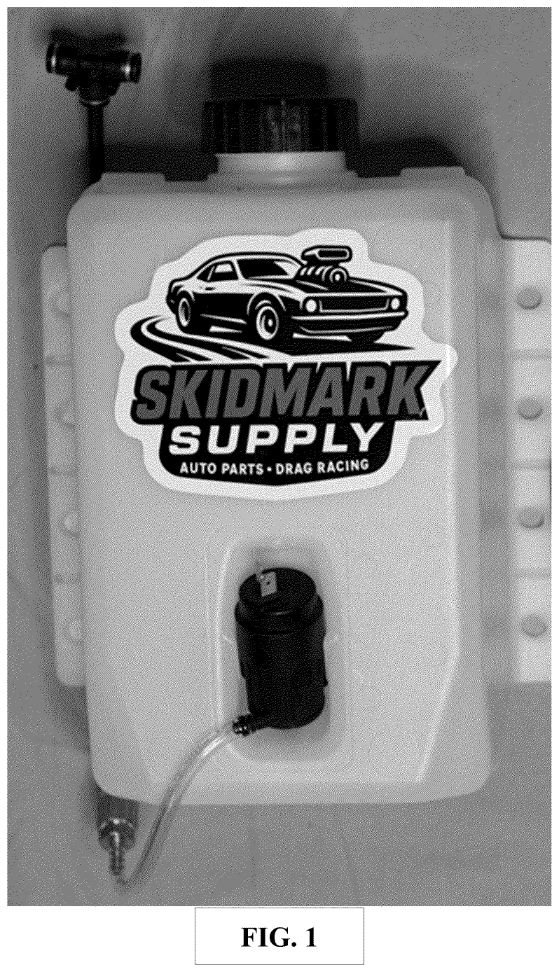

The various fluid release device and system embodiments disclosed or contemplated herein include a fluid reservoir and a means to move the fluid from the reservoir to the tires. FIG. 1 shows a reservoir that has a top cap to fill/refill the reservoir with fluid; mounting side panels for the reservoir to be securely mounted within the trunk or area suitable for reservoir storage; a nozzle to connect to fluid lines, and a component to provide pressure that can be controlled by the user.

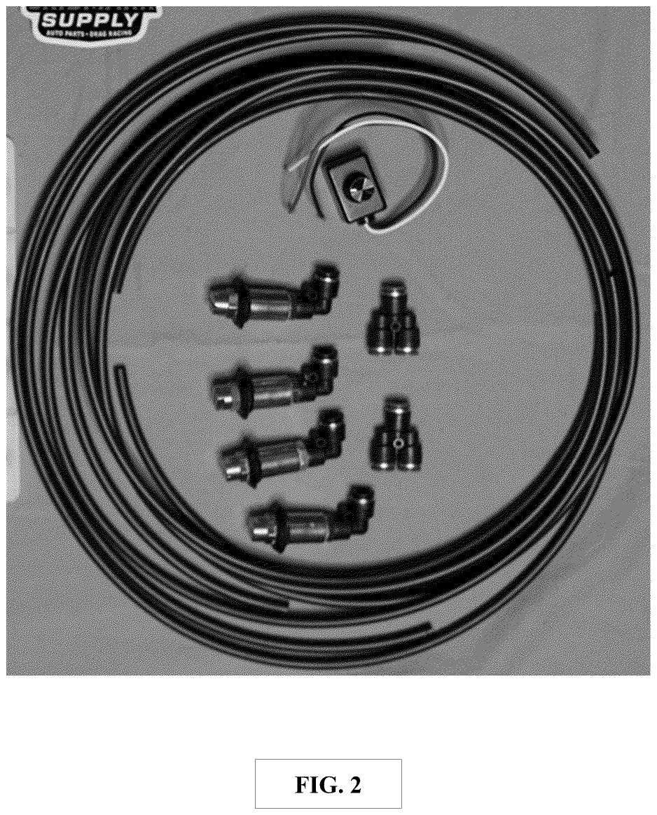

FIG. 2 shows the fluid lines, four nozzles for directing two nozzles toward each tire that spins from rotational energy, adapters to attach the fluid lines to the fluid reservoir, and a user controller button. In another embodiment, the device could be comprised of one to multiple nozzles for each tire. In another embodiment, the device has two nozzles for each tire wherein one nozzle is directed to a first section of a tire and a second nozzle is directed to a second portion. In another embodiment, a nozzle is directed to the front portion of the tire and a second nozzle is directed to the rear portion of the tire.

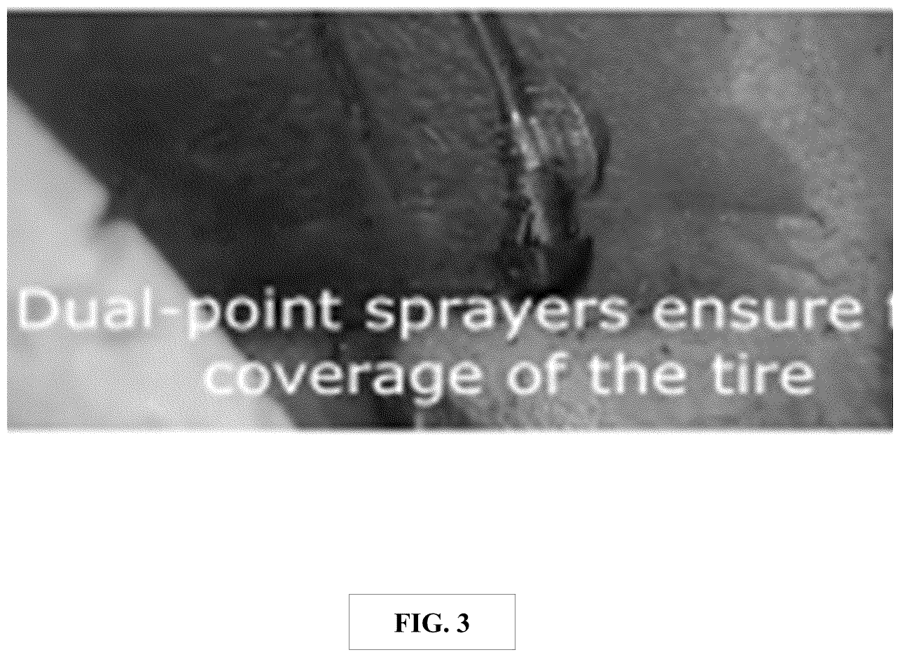

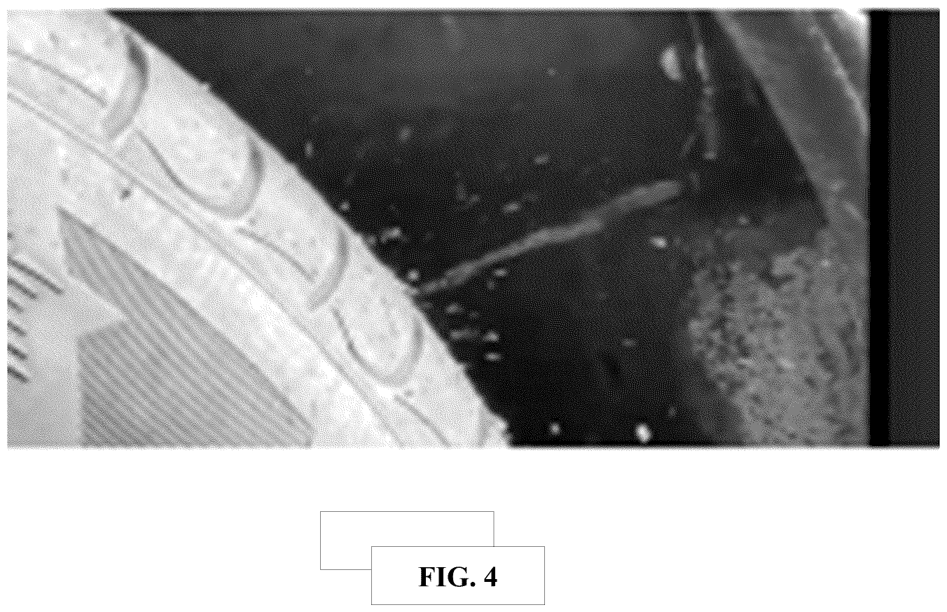

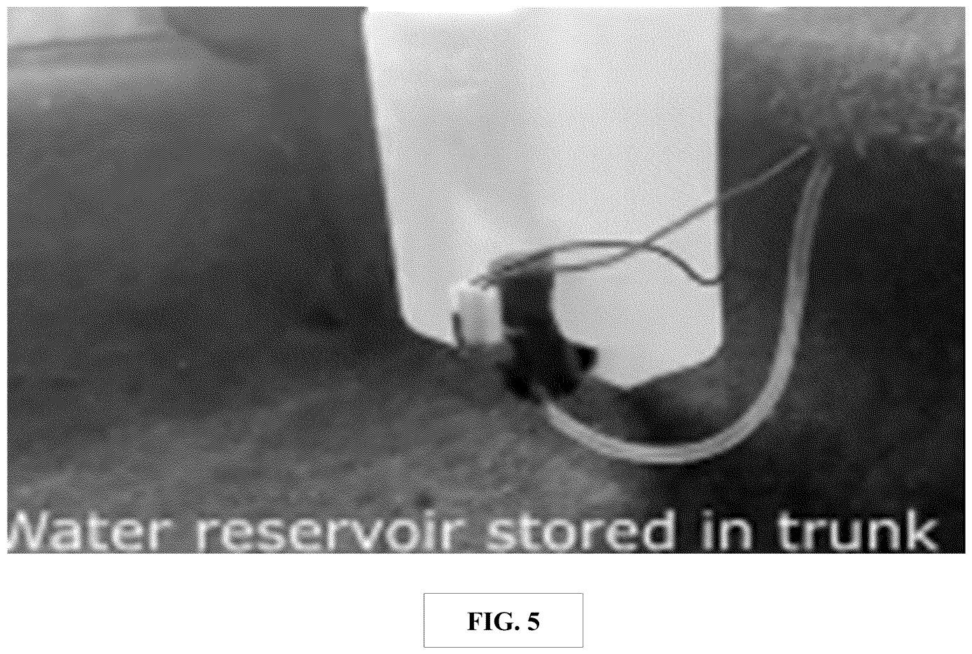

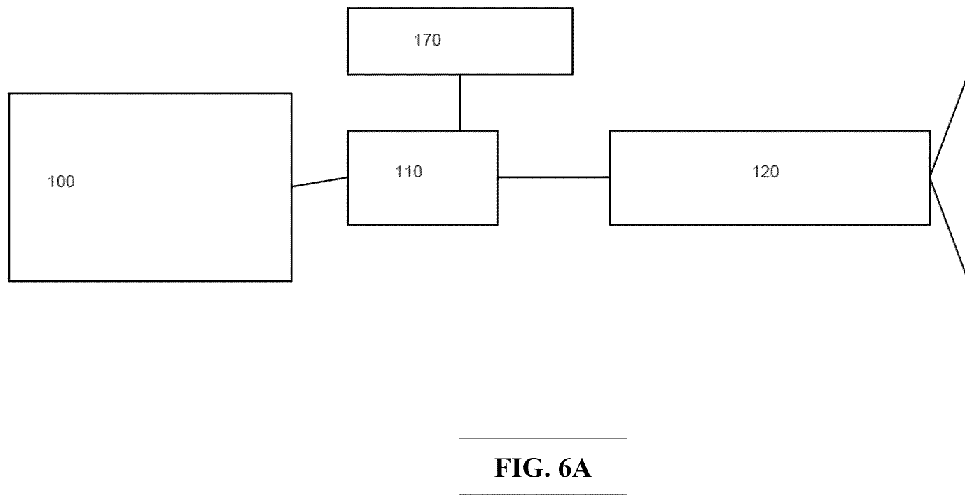

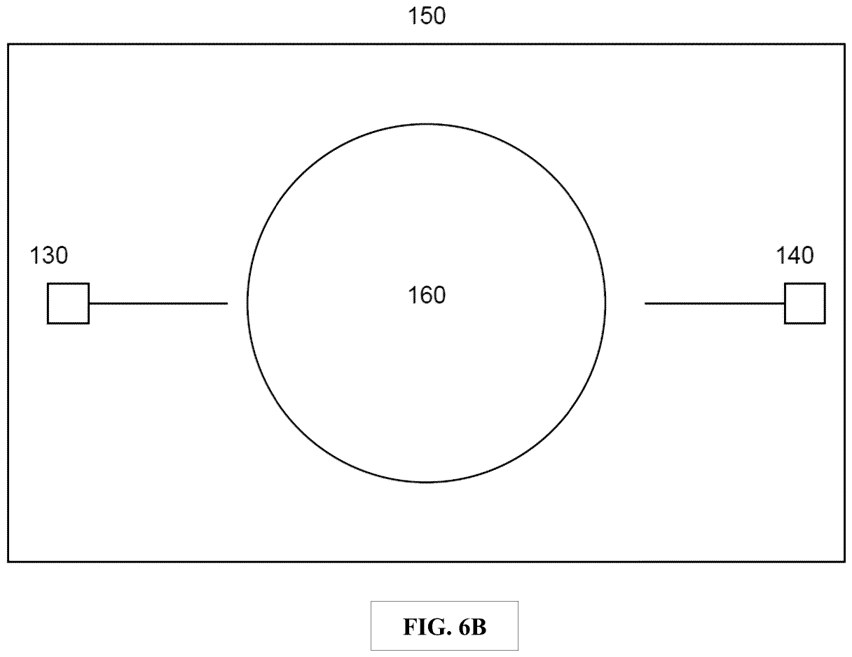

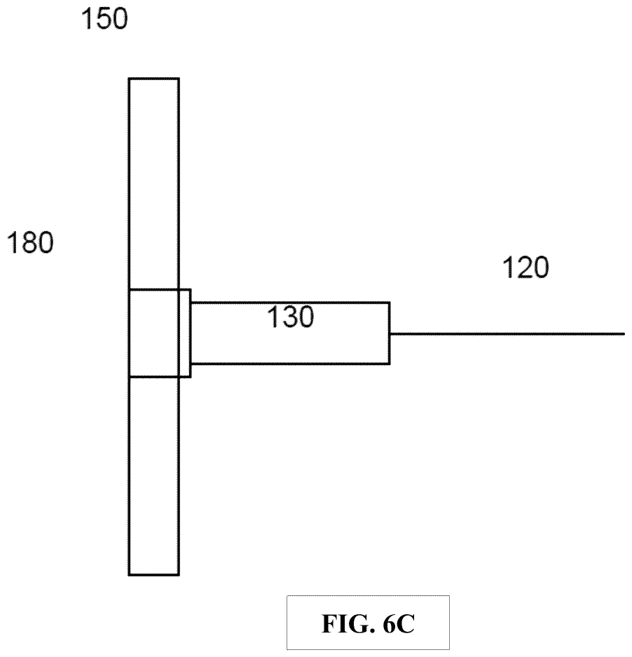

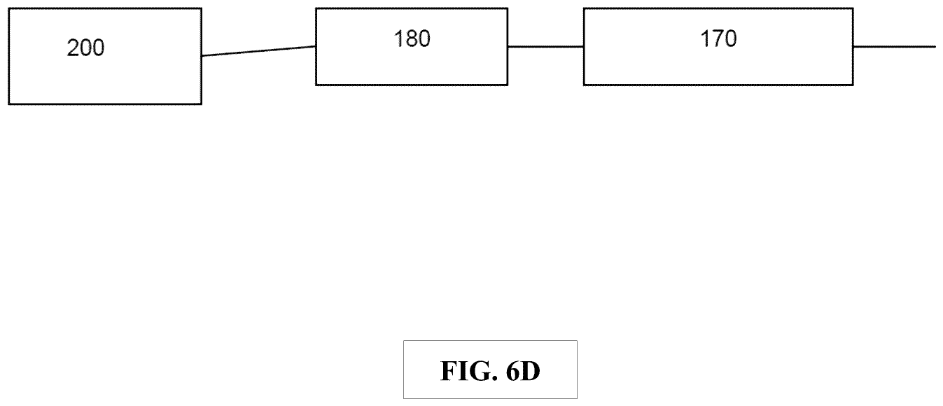

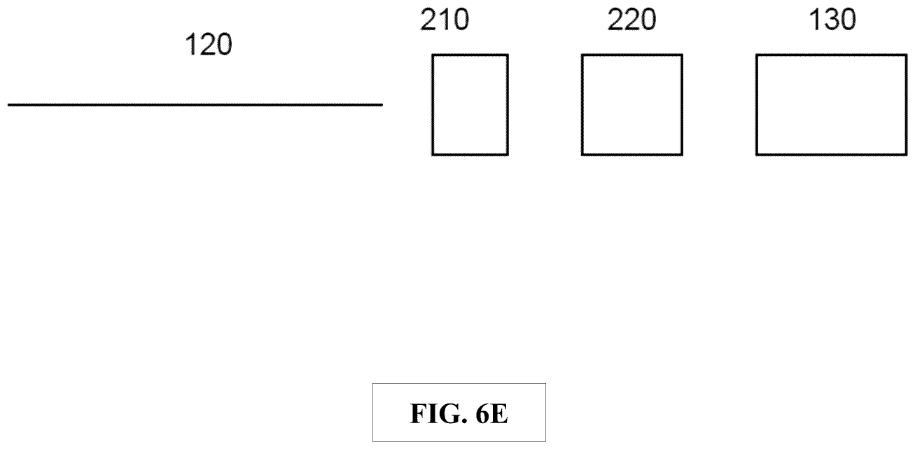

In one embodiment, a system will have a reservoir of a liquid mounted inside a trunk space or proximate to a wheel that connects to a conduit piping that extends to the wheel wells of the vehicle. FIG. 3 shows an example of a sprayer mounted to a wheel well, and FIG. 4 shows the fluid release from the nozzle onto a tire. FIG. 5 shows the electrical connection of the reservoir that allows the user to control dispensing of the fluid onto the tires. Following FIG. 6A-E, the system may be powered by a vehicle battery (200) and include a control interface (180) with adjustable flow control (170). The system may include sensors such as fluid level indicators and automatic activation triggers.

In another embodiment, the system includes a 1-4 quart fluid reservoir, an external replaceable 12V pump, a polymeric tubing, and dual spray nozzles positioned within a wheel well. Flow may be controlled via PWM or equivalent mechanisms. Using FIG. 6A-E as a guide, the system supports modular fittings, filters, and alternative material configurations. In one embodiment, the system comprises a fluid reservoir (100) in fluid communication with a pumping mechanism (110), which delivers fluid through a fluid distribution network (120) to one or more spray outlets (130, 140) positioned within a wheel well (150) and directed toward a vehicle tire (160). The pumping mechanism may include electric, diaphragm, pressure-driven, or gravity-fed systems. A flow regulation device (170) such as a PWM controller may regulate fluid delivery. A control interface (180) allows manual or automatic operation.

Example embodiments of fluids include water, calcium chloride, antifreeze, washer fluid, beet juice, chlorine bleach, dyes or a combination thereof. The liquid could therefore increase traction or decrease traction, depending on the fluid. In additional embodiments, the liquid could produce smoke once it contacts the tire and/or surface, and the fluid can enhance or change the color of smoke produced, either independently or further activated from spinning tires.

The liquid dispensing would be controlled by the driver or another occupant with a dispensing mechanism such as a button, switch, lever or pulling mechanism. The controller, or elsewhere within the system, may contain an adjusting mechanism, such as a dial, for altering the liquid dispensing intensity. Alternatively or additionally, the fluid can be delivered automatically depending on whether the vehicle is on, whether the vehicle is moving, or whether the car reaches a certain speed.

In another embodiment, a volume sensor can be positioned within or near the fluid reservoir to provide an alert to the user that the fluid is low and should be refilled to avoid traction damage or undesired increase in traction that would propel the vehicle more than a user would expect when using the fluid dispensing device.

The system could be developed for any vehicle with tires, including a motorcycle, motorized bicycle, or motorized scooter.

In one embodiment, the reservoir is mounted inside a trunk with screws through the mounting portions of a reservoir container as shown in FIG. 1. The pump shown in FIG. 1 is mounted close to the reservoir. A hole is drilled into the wheel well for each fluid line/nozzle that is utilized for the device. The nozzles can come from different angles and can be directed to different portions of the tire, or they can all be directed to one position on the tire, such as the central point of the tire relative to the wheel well. The fluid lines extend from the pump to the nozzles, and can be affixed to the trunk or any surface with zip ties, tape, glue or any other securing component. In one embodiment, the fluid lines are of equal length to provide equal dispensing volumes from each fluid line.

In another embodiment, the nozzles are not fixed directly to the wheel well but are attached indirectly, or through a different area of the vehicle. For example, the nozzles can be affixed to a mud flap wherein the nozzles are still directed to the wheel. In another embodiment, the system is mounted to a mud flap support structure behind one or more axles. Spray outlets are distributed across the width of the vehicle to apply fluid to tires or roadway surfaces. This configuration is suitable for commercial vehicles and multi-axle systems. Multiple reservoirs and pumps may be used.

In another embodiment, the nozzles are directed to another surface, and the fluid is directed to the tire from the surface, directly or indirectly.

In another embodiment, the fluid reservoir is replaced or supplemented with a pressurized gas that, upon activation, can deposit gas on or near the tires. The gas may be a decorative smoke or other aesthetic visible gas.

While the various systems described above are separate implementations, any of the individual components, mechanisms, or devices, and related features and functionality, within the various system embodiments described in detail above can be incorporated into any of the other system embodiments herein.

The terms “about” and “substantially,” as used herein, refers to variation that can occur (including in numerical quantity or structure), for example, through typical measuring techniques and equipment, with respect to any quantifiable variable, including, but not limited to, mass, volume, time, distance, wave length, frequency, voltage, current, and electromagnetic field. Further, there is certain inadvertent error and variation in the real world that is likely through differences in the manufacture, source, or precision of the components used to make the various components or carry out the methods and the like. The terms “about” and “substantially” also encompass these variations. The term “about” and “substantially” can include any variation of 5% or 10%, or any amount-including any integer-between 0% and 10%. Further, whether or not modified by the term “about” or “substantially,” the claims include equivalents to the quantities or amounts.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾. This applies regardless of the breadth of the range. Although the various embodiments have been described with reference to preferred implementations, persons skilled in the art will recognize that changes may be made in form and detail without departing from the spirit and scope thereof.

Although the various embodiments have been described with reference to preferred implementations, persons skilled in the art will recognize that changes may be made in form and detail without departing from the spirit and scope thereof.

What is claimed is:

1. A fluid dispensing device for deposition of fluid on to one or more vehicle tires comprising:
(a) a fluid reservoir;
(b) a pumping mechanism to draw fluid from the fluid reservoir; and
(c) at least one nozzle attached to the pumping mechanism.

2. The fluid dispensing device of claim 1 wherein the fluid dispensing device additionally comprises a controlling mechanism wherein the controlling mechanism can control the deposition of the fluid onto the vehicle tires.

3. The controlling mechanism from claim 2 wherein the controlling mechanism is a button.

4. The fluid dispensing device of claim 1 wherein the fluid dispensing device comprises 2-8 nozzles.

5. The fluid dispensing device of claim 1 wherein the fluid is one or more of water, calcium chloride, antifreeze, washer fluid, cleaning fluid, beet juice, chlorine bleach or a dye.

6. The fluid dispensing device of claim 1 wherein the fluid dispensing device has at least one nozzle directed to each vehicle tire that spins from rotational energy.

7. The fluid dispensing device of claim 1 wherein the fluid dispensing device comprises a fluid volume sensor.

8. The fluid dispensing device of claim 1 wherein the at least one nozzle is affixed to a wheel well of a vehicle.

9. The fluid dispensing device of claim 1 wherein the at least one nozzle is affixed to a mud flap of a vehicle.

10. A fluid dispensing device for deposition of fluid on to one or more vehicle tires to modify vehicle traction between the vehicle tires and a surface comprising:
(a) a fluid reservoir containing a fluid capable of providing increased traction between the vehicle tires and the surface;
(b) a pumping mechanism to draw fluid from the fluid reservoir; and
(c) at least one nozzle attached to the pumping mechanism.

11. A vehicle-mounted fluid delivery system comprising a fluid source, delivery mechanism, and at least one outlet positioned within a wheel housing or along a mud flap support structure.

12. The system of claim 11 wherein multiple outlets are positioned around a tire or across a vehicle width.

13. The system of claim 11 wherein the delivery mechanism includes an electric pump, pressure system, or gravity system.

14. The system of claim 11 including adjustable flow control.

15. The system of claim 11 wherein outlets are mounted in a wheel well.

16. The system of claim 11 wherein outlets are mounted to a mud flap bar.

17. The system of claim 11 configured for multi-axle vehicles.
